(19) United States
(12) Patent Application Publication
(10) Pub. No.: US 2025/0383467 A1
(43) Pub. Date: Dec. 18, 2025

(54) User-Reconfigurable Metal Detector Customization and Installation System and Method Therefor

(71) Applicant: Garrett Electronics, Inc., Garland, TX (US)

(72) Inventors: Stephen M. Novakovich, JR., Dallas, TX (US); J. Brian Head, Frisco, TX (US)

(73) Assignee: Garrett Electronics, Inc., Garland, TX (US)

(21) Appl. No.: 18/745,727

(22) Filed: Jun. 17, 2024

Related U.S. Application Data
(63) Continuation-in-part of application No. 18/745,691, filed on Jun. 17, 2024.

(51) Int. Cl. G01V 3/10

(52) U.S. Cl. CPC G01V 3/10

(57) ABSTRACT

Systems and techniques for customizing and installing a configuration of a user-reconfigurable metal detector. In embodiments, a user-reconfigurable metal detector system is configured to enable customization of a configuration for the user-reconfigurable metal detector and to enable installation of the customized configuration on the user-reconfigurable metal detector. In embodiments, users interact with an update system to customize the configuration of the user-reconfigurable metal detector, and to deploy or install the customized configuration onto the user-reconfigurable metal detector. In embodiments, a current configuration of the user-reconfigurable metal detector may be replaced with the new customized configuration.

### CROSS-REFERENCE TO RELATED APPLICATIONS

The present application is a continuation-in-part of pending and co-owned U.S. patent application Ser. No. 18/745,691, filed Jun. 17, 2024, the entirety of which is herein incorporated by reference for all purposes.

### TECHNICAL FIELD

The present disclosure relates generally to metal detectors, and more particularly to a user-reconfigurable metal detector.

### BACKGROUND

Metal detectors are wonderful devices designed to detect the presence of metals within a surrounding area. They operate by generating a magnetic field and analyzing the response from metal objects when this field is disturbed. Metal detectors are widely used in various applications, including security screening at airports, construction to locate buried utilities, archaeology for uncovering historical artifacts, and by hobbyists for treasure hunting. Metal detectors can range from handheld units to larger (and often more complex) systems and are valued for their ability to locate metal objects that are not readily visible or accessible, providing a means for non-invasive exploration of various environments.

Metal detectors have been in use for over seven decades, with advancements and improvements being made in response to user requirements and emerging technologies. The development of digital metal detectors in the 1970s, which utilized microprocessors for control functions and signal processing, marked a major milestone in the evolution of metal detectors. As microprocessors became more powerful, signal processing evolved from simple measurement and display to full digital signal processing systems.

One notable feature of these digital systems was the ability to update the operation of the metal detector through software patches that were used to patch and fix bugs and secure the system. Typically, these updates are performed by the manufacturer or a repair shop.

However, the features, capabilities, and functionality of a metal detector are typically set during manufacturing, with limited upgrade capabilities available afterwards. For example, metal detectors are typically manufactured in a variety of models, each offering a distinct set of features. These features, which can range from detection capabilities to user interface design, are predetermined at the time of manufacturing. Consequently, if a customer desires to upgrade or change their metal detecting capabilities, the customer is generally forced to replace their current metal detector with a different model of the metal detector that comes with the desired features, often by purchasing the new metal detector.

For example, a customer who initially purchases an entry-level metal detector, equipped with basic features, would find themselves restricted to the functionalities offered by this entry-level metal detector. If the customer wishes to access more advanced features or a higher level of performance, the customer may have to invest in a higher-level metal detector. This upgrade process often involves a substantial additional expenditure, making it a costly endeavor for the customer.

Conversely, a customer may purchase a higher-end metal detector model, including extensive and advanced features, only to later discover that many of these features are not necessary for the customer's specific metal detecting activities. Such a customer is then left with a device that includes features that are not being utilized. Perhaps worse still, this customer may benefit from some of the advanced features but may find that they would prefer or require lower-end features for some specific aspects of the metal detecting activities. This mismatch can leave the customer with a device that is not fully aligned with their individual needs, as they are unable to combine advanced and basic features within a single model.

The deficiencies of current metal detector cause customers to face particular constraints when their metal detecting requirements span across different applications or use cases. If a customer purchases a metal detector that is specifically tailored for one application, such as relic hunting, and later decides to engage in a different metal detecting activity, like gold prospecting or law enforcement searches, the customer may be forced to purchase an entirely separate metal detector designed for that new application. This is because the features and functionalities of their existing metal detector are optimized for the initial use case and are not readily transferable or adaptable to the new application. This inflexibility not only forces customers to incur additional costs by buying multiple metal detectors for different applications but also leads to the underutilization of their original equipment.

### SUMMARY

The present disclosure achieves technical advantages as systems, methods, and computer-readable storage media with functionality for customizing and installing a configuration of a user-reconfigurable metal detector. In particular, a user-reconfigurable metal detector system may be configured to enable customization of a configuration for the user-reconfigurable metal detector and to enable installation of the customized configuration on the user-reconfigurable metal detector. In embodiments, users may interact with an update system to customize the configuration of the user-reconfigurable metal detector, and to deploy or install the customized configuration onto the user-reconfigurable metal detector. In embodiments, a current configuration of the user-reconfigurable metal detector may be replaced with a new customized configuration.

In embodiments, customizing the configuration of the user-reconfigurable metal detector may include configuring the set of features for the customized configuration, which may include selecting the features for the set of features from a set of available features associated with the user-reconfigurable metal detector and/or configuring the selected features. Configuring the selected features may include configuring a performance level, activation status, etc., for each of the selected features. In embodiments, configuring the set of features for the customized configuration may include a request to one or more of downgrade, upgrade, remove, add, enable, or disable for one or more of the features in the set of features for the customized configuration.

In embodiments, customizing a configuration for the user-reconfigurable metal detector may include selecting a product profile that includes a set of features selected with which to configure the user-reconfigurable metal detector. In embodiments, the selected product profile may replace the current configuration of the user-reconfigurable metal detector, which may include configuring the set of features with which the user-reconfigurable metal detector is currently configured to match the set of features, and the configuration of each feature, of the selected product profile, and/or may include replacing a current product profile of the user-reconfigurable metal detector.

As such, the present disclosure provides for a system integrated into a practical application with meaningful limitations as an integrated system with functionality for customizing and installing configurations for a user-reconfigurable metal detector. The functionality of the system of embodiments provides for a user-reconfigurable metal detector system with enhanced adaptability and customization capabilities. For example, the system of embodiments, allows for dynamic configuration of the metal detector's features without the user needing to replace hardware components. This results in the technical advantage that users are able adapt their metal detector to various metal detecting scenarios, applications, and preferences, extending the utility and lifespan of the device, which represents an improved metal detector.

Another significant technical improvement provide by the system of embodiments is that it provides the ability to select and modify the performance levels and activation statuses of individual features. This granular control over the configuration enables users to optimize the metal detector's performance for specific tasks, such as improving detection depth or adjusting sensitivity, which can lead to more efficient and effective metal detecting operation.

Another technical improvement is the system's ability to support multiple product profiles on a single hardware platform. This functionality allows users to switch between different classifications of metal detecting operations, such as relic hunting, law enforcement, gold hunting, or coin hunting, without the purchase of separate, specialized devices, providing users with a versatile tool that can adapt to various metal detecting scenarios.

Still another technical improvement includes the system's ability to enable user with a user-driven reconfiguration process that can be performed independently, eliminating the traditional reliance on manufacturers or service centers for upgrades or modifications. This self-service model not only enhances the user experience by provides greater control over the device's functionality and reduces downtime and associated costs.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for metal detectors configuration. In doing so, the present disclosure goes well beyond a mere application the manual process to a computer. Accordingly, the claims herein necessarily provide a technological solution that overcomes a technological problem.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of customizing and installing a configuration for a reconfigurable metal detector. It is a further object of the disclosure to provide a system for customizing and installing a configuration for a reconfigurable metal detector, and a computer-based tool for customizing and installing a configuration for a reconfigurable metal detector. These and other objects are provided by the present disclosure, including at least the following embodiments.

In one particular embodiment, a method of customizing and installing a configuration for a reconfigurable metal detector is provided. The method includes customizing a first configuration for a metal detector to include a first set of features selected from a set of available features associated with the metal detector. In embodiments, the set of available features is constructed from a set of capabilities associated with hardware components of the metal detector, and the first configuration is configured to support a first classification of metal detecting operations of the metal detector. The method also includes installing the first configuration into the metal detector. In embodiments, the installing enables the metal detector to operate according to the first configuration. The method further includes customizing a second configuration for the metal detector to include a second set of features selected from the set of available features different from the first set of features of the first configuration. In embodiments, the second configuration is configured to support a second classification of metal detecting operations of the metal detector different from the first classification of metal detecting operations. The method also includes installing the second configuration into the metal detector by replacing the first configuration. In embodiments, the installing of the second configuration reconfigures the metal detector to operate according to the second configuration without replacing hardware components of the metal detector.

In another embodiment, a system for customizing and installing a configuration for a reconfigurable metal detector is provided. The system comprises at least one processor and a memory operably coupled to the at least one processor and storing processor-readable code that, when executed by the at least one processor, is configured to perform operations. The operations include customizing a first configuration for a metal detector to include a first set of features selected from a set of available features associated with the metal detector. In embodiments, the set of available features is constructed from a set of capabilities associated with hardware components of the metal detector, and the first configuration is configured to support a first classification of metal detecting operations of the metal detector. The operations also include installing the first configuration into the metal detector. In embodiments, the installing enables the metal detector to operate according to the first configuration. The operations further include customizing a second configuration for the metal detector to include a second set of features selected from the set of available features different from the first set of features of the first configuration. In embodiments, the second configuration is configured to support a second classification of metal detecting operations of the metal detector different from the first classification of metal detecting operations. The operations also include installing the second configuration into the metal detector by replacing the first configuration. In embodiments, the installing of the second configuration reconfigures the metal detector to operate according to the second configuration without replacing hardware components of the metal detector.

In yet another embodiment, a computer-based tool for customizing and installing a configuration for a reconfigurable metal detector is provided. The computer-based tool including non-transitory computer readable media having stored thereon computer code which, when executed by a processor, causes a computing device to perform operations. The operations include customizing a first configuration for a metal detector to include a first set of features selected from a set of available features associated with the metal detector. In embodiments, the set of available features is constructed from a set of capabilities associated with hardware components of the metal detector, and the first configuration is configured to support a first classification of metal detecting operations of the metal detector. The operations also include installing the first configuration into the metal detector. In embodiments, the installing enables the metal detector to operate according to the first configuration. The operations further include customizing a second configuration for the metal detector to include a second set of features selected from the set of available features different from the first set of features of the first configuration. In embodiments, the second configuration is configured to support a second classification of metal detecting operations of the metal detector different from the first classification of metal detecting operations. The operations also include installing the second configuration into the metal detector by replacing the first configuration. In embodiments, the installing of the second configuration reconfigures the metal detector to operate according to the second configuration without replacing hardware components of the metal detector.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary user-reconfigurable metal detector system configured with capabilities and functionality for customizing and installing a configuration for a user-reconfigurable metal detector in accordance with embodiments of the present disclosure.

FIG. 2 is a block diagram of an exemplary user-reconfigurable metal detector configured with capabilities and functionality for customization and installation of a configuration for a user-reconfigurable metal detector in accordance with embodiments of the present disclosure.

FIG. 3 is a block diagram of an exemplary local installer configured with capabilities and functionality for customizing and installing a configuration for a user-reconfigurable metal detector in accordance with embodiments of the present disclosure.

FIGS. 4A and 4B show a high-level flow diagram of operation of a system configured for providing functionality for customizing and installing a configuration for a user-reconfigurable metal detector in accordance with embodiments of the present disclosure.

FIGS. 5A-5F show diagrams illustrating operations to customize and install a configuration for a user-reconfigurable metal detector in accordance with embodiments of the present disclosure.

FIG. 6 is a flowchart illustrating operations for customizing and installing a configuration for a user-reconfigurable metal detector in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

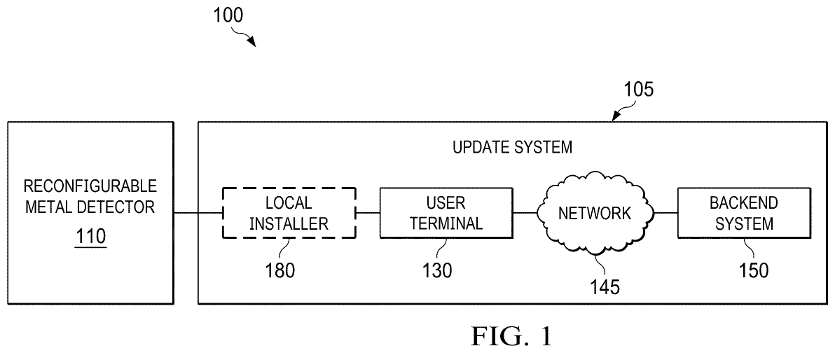

FIG. 1 is a block diagram of an exemplary user-reconfigurable metal detector system 100 configured with capabilities and functionality for customizing and installing a configuration for a user-reconfigurable metal detector in accordance with embodiments of the present disclosure. As shown in FIG. 1, system 100 may include a user-reconfigurable metal detector 110, an update system 105, a user terminal 130, and a network 145. The update system 105 may include a local installer 180 and a backend system 150. These components, and their individual components, may cooperatively operate to provide functionality in accordance with the discussion herein. In particular, the user-reconfigurable metal detector system 100 may be configured to enable customization of a configuration for the user-reconfigurable metal detector 110 and to enable installation of the customized configuration on the user-reconfigurable metal detector 110. In embodiments, customizing the configuration of the user-reconfigurable metal detector 110 may include configuring a set of features to be included in the user-reconfigurable metal detector 110. Configuring the set of features to be included in the user-reconfigurable metal detector 110 may include including one or more features in the customized configurations, where the one or more features may be activated for the user-reconfigurable metal detector 110 in response to installing the customized configuration on the user-reconfigurable metal detector 110.

In embodiments, users may interact with the update system 105 (e.g., with the backend system 150 and/or with the local installer 180) to customize the configuration of the user-reconfigurable metal detector 110, and to deploy or install the customized configuration onto the user-reconfigurable metal detector 110. In embodiments, a current configuration of the user-reconfigurable metal detector 110 may be replaced with a new customized configuration. In embodiments, customizing a configuration of the user-reconfigurable metal detector 110 may include selecting features associated with the user-reconfigurable metal detector 110 to change, add, remove, enable, or disable, and/or selecting a new product profile including a particular set of features for installation into the user-reconfigurable metal detector 110. In embodiments, the update system 105 may be configured to manage the installation of the customized configuration into the user-reconfigurable metal detector 11. This process may transform the user-reconfigurable metal detector 110 into a versatile tool that can be tailored to various metal detecting activities, applications, and user preferences without the expense and inconvenience of purchasing multiple, fixed-functionality devices.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

The user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, the user terminal 130 may provide a user interface that may be configured to provide an interface (e.g., a graphical user interface (GUI)) structured to facilitate a user interacting with the system 100, e.g., via the network 145, to execute and leverage the features provided by the cooperative operations of the system 100. It is noted that although the user terminal 130 may be illustrated as part of update the system 105, in embodiments, the user terminal 130 may include a component that is separate and distinct from the update system 105, and as such, the illustration of the user terminal 130 as part of the update system 105 is for illustrative purposes and not by way of limitation.

In embodiments, the user terminal 130 may be configured to operate as the interface for user interaction with the reconfigurable metal detector system 100. In embodiments, the user terminal 130 may be configured to present a user interface generated by the local installer 180, which may provide a mechanism for users to initiate and manage the reconfiguration process of their metal detector. Additionally, or alternatively, the user terminal 130 may be configured to present a user interface provided by the backend system 150, which may be used by the user to access and select from a variety of features and product profiles available for their device. This dual capability provides a mechanism for interacting with the local installer 180 to make immediate changes and/or with the backend system 150 for a broader range of customization and/or reconfiguration options. In embodiments, user terminal 130 may be configured to communicate with other components of system 100.

In embodiments, the network 145 may facilitate communications between the various components of the system 100 (e.g., the user-reconfigurable metal detector 110, the backend system 150, the local installer 180, and/or the user terminal 130). The network 145 may include one or more of a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc. It is noted that although the network 145 may be illustrated as part of update system 105, in embodiments, the network 145 may include a component that is separate and distinct from update system 105, and as such, the illustration of the network 145 as part of the update system 105 is for illustrative purposes and not by way of limitation.

It is noted that the user-reconfigurable metal detector 110 represents an innovative approach and solution to the deficiencies of current metal detecting devices. Unlike traditional metal detectors, which are static in their feature set post-manufacture, the user-reconfigurable metal detector 110 is configured to be dynamic and adaptable to the evolving and changing requirements of its users. This functionality of the user-reconfigurable metal detector 110 may allow for a single hardware platform to serve multiple purposes, and to be configured for multiple classifications of metal detecting operations, which may include different performance levels and/or different metal detecting applications.

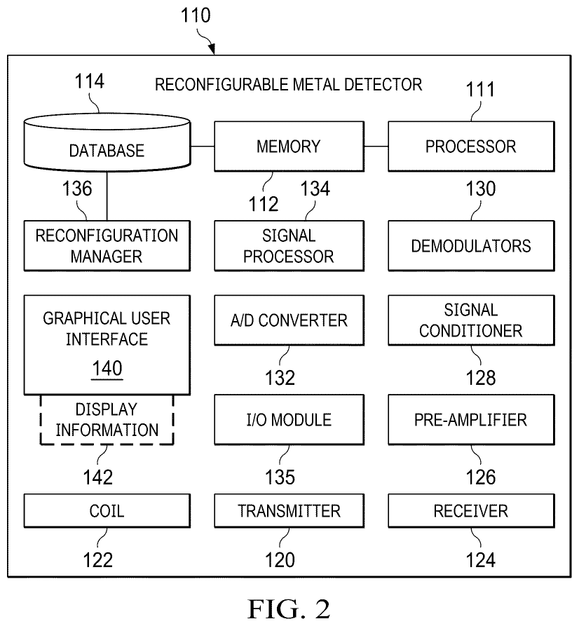

In embodiments, the user-reconfigurable metal detector 110 may include a set of hardware components that form a common hardware platform. These components are configured to provide a wide range of functionalities and capabilities, which remain constant throughout the life of the user-reconfigurable metal detector 110. A specific configuration of the user-reconfigurable metal detector 110 will now be discussed with reference to FIG. 2.

FIG. 2 is a block diagram of an exemplary user-reconfigurable metal detector 110 configured with capabilities and functionality for customization and installation of a configuration for a user-reconfigurable metal detector in accordance with embodiments of the present disclosure. It is noted that the functional blocks, and components thereof, of the user-reconfigurable metal detector 110 illustrated in FIG. 2 may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of the user-reconfigurable metal detector 110 illustrated in FIG. 2 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of the user-reconfigurable metal detector 110 illustrated in FIG. 2 described herein is provided for purposes of illustration, rather than by way of limitation and that functionalities described as being provided by different functional blocks may be combined into a single component or may be provided via computing resources disposed in a cloud-based environment accessible over a network.

As shown in FIG. 2, the user-reconfigurable metal detector 110 may include various components. For example, the user-reconfigurable metal detector 110 may include a processor 111. The processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of the processor 111 may comprise code segments (e.g., software, firmware, and/or hardware logic) executable in hardware, such as a processor, to perform the tasks and functions described herein. In yet other embodiments, the processor 111 may be implemented as a combination of hardware and software. The processor 111 may be communicatively coupled to the memory 112.

The memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. The memory 112 may comprise a processor readable medium configured to store one or more instruction sets (e.g., software, firmware, etc.) which, when executed by a processor (e.g., one or more processors of the processor 111), perform tasks and functions as described herein.

The memory 112 may also be configured to facilitate storage operations. For example, the memory 112 may comprise a database 114 for storing various information related to operations of the user-reconfigurable metal detector 110. For example, the database 114 may store configuration information related to operations of the user-reconfigurable metal detector 110. In embodiments, the database 114 may store information related to the identification details of the user-reconfigurable metal detector 110, such as its ID and model number, a record of the current software version installed on the user-reconfigurable metal detector 110, the current configuration of the user-reconfigurable metal detector 110, such as the current product profile and/or the set of features in the current configuration of the user-reconfigurable metal detector 110, a configuration of each feature in the set of features of the current configuration, and/or other configuration parameters such as detection modes, sensitivity levels, audio feedback options, calibration settings, user preferences, etc. The database 114 is illustrated as integrated into the memory 112, but in some embodiments, the database 114 may be provided as a separate storage module or may be provided as a cloud-based storage module. Additionally, or alternatively, the database 114 may be a single database, or may be a distributed database implemented over a plurality of database modules.

The transmitter 120 of the user-reconfigurable metal detector 110 may be configured to generate a transmit wave, which may include an electromagnetic wave that propagates through the ground or other media where the user-reconfigurable metal detector 110 may be operating. In embodiments, the characteristics of the transmit wave generated by the transmitter 120, such as its frequency, power, and waveform, may be tailored to optimize the operations (e.g., performance and/or metal detecting application) of the user-reconfigurable metal detector 110. In some embodiments, the transmitter 120 may be configured to generate multiple frequencies simultaneously or to switch between frequencies to enhance detection capabilities across a range of metal types and ground conditions. In embodiments, the capability and functionality of the transmitter 120 to adjust the transmit wave parameters (e.g., in cooperation with the functionality of the processor 111) may enable the fine-tuning of user-reconfigurable metal detector 110's sensitivity and selectivity, which may improve the probability of detecting desired targets while minimizing interference and false signals.

The coil 122 may be configured to generate a magnetic field in response to the transmit wave produced by the transmitter 120. In embodiments, the coil 122 may create an electromagnetic interaction with metallic objects within its vicinity. When a metal object disturbs this magnetic field, the coil 122 may detect the response as a receive signal, which may represent a reflection of the transmit wave altered by the presence of the object. This receive signal may be provided to the receiver 124 for further processing.

The receiver 124 may be configured to capture the receive signal that is generated when the magnetic field produced by the coil 122 interacts with a metallic object. In embodiments, the functionality and capability of the receiver 124 may include a sensitivity to the subtle variations in the receive signal, which may include changes in amplitude, phase, and frequency that occur as a result of the metal object's properties and its interaction with the magnetic field. Upon capturing the receive signal, the receiver 124 may provide the captured receive signal to subsequent stages for amplification, conditioning, demodulation, and/or analysis. In some embodiments, the receiver 124 may also include filtering mechanisms to reduce noise and enhance the clarity of the receive signal.

The pre-amplifier 126 may be configured to amplify the receive signal detected by the coil 122 and captured by the receiver 124. For example, the pre-amplifier 126 may be configured to increase or boost the strength of the receive signal to a level that is suitable for further processing while preserving the integrity of the signal's information content. This amplification may be particularly useful for weak signals that may be a result of deep or small targets, ensuring that these signals are not lost due to noise. In some embodiments, the pre-amplifier 126 may include adjustable gain settings, which may enable the amplification factor to be modified, which may result in a higher gain. In some embodiments, the pre-amplifier 126 may incorporate noise reduction mechanisms to minimize the impact of noise on the signal quality.

The signal conditioner 128 may be configured to condition the amplified receive signal from the pre-amplifier 126, preparing it for accurate and efficient demodulation and analysis. In some embodiments, the signal conditioner 128 may include various filters, such as band-pass or notch filters, to selectively pass frequencies of interest while attenuating unwanted frequencies that could interfere with signal interpretation. In some embodiments, the signal conditioner 128 may employ automatic gain control (AGC) to dynamically adjust the signal level, ensuring consistent signal strength across varying detection conditions. In some embodiments, the signal conditioner 128 may include shaping functionality to modify the waveform of the receive signal, enhancing the detector's ability to distinguish between different types of metal objects. In some embodiments, the signal conditioner 128 may include functionality to correct phase shifts and balance the signal, which may be useful in compensating for ground mineralization effects.

The one or more demodulators 130 of the reconfigurable metal detector 110 may be configured to demodulate the conditioned receive signal provided by the signal conditioner 128. The functionality of the one or more demodulators 130 to demodulate the receive signal may include extracting the baseband signal from the carrier wave, which in some embodiments may include the receive signal that has been influenced by the presence of a metallic object. In embodiments, the one or more demodulators 130 may leverage various demodulation techniques, such as amplitude demodulation, frequency demodulation, or phase demodulation, depending on the nature of the transmit wave and the type of information encoded in the receive signal. In some embodiments, the one or more demodulators 130 may be configured to process multiple demodulation schemes simultaneously to accommodate different signal characteristics, which may enhance the metal detector's ability to differentiate between various metal types and conditions. The demodulated signal may be provided to the analog-to-digital (A/D) converter 132 for digital conversion, enabling the signal processor 134 to perform a detailed analysis of the signal's content to accurately identify and characterize the detected metal object.

The A/D converter 132 may be configured to convert the analog demodulated signal from the demodulators 130 into a digital format to enable the subsequent digital processing of the signal by the signal processor 134. In some embodiments, the A/D converter 132 may be configured to operate at high sampling rates, which may enable the capturing of the demodulated signal at a frequency that allows for the detection of rapid changes and transient signals.

The signal processor 134 may be configured to analyze the digital signal provided by the A/D converter 132 to provide metal detecting functionality. In embodiments, the signal processor 134 may operate in cooperation with the processor 111 to apply algorithms to interpret the digital signal, which may provide functionality for distinguishing between various types of metals, assessing the depth and size of the detected objects, and/or determining the likelihood of the presence of specific metal types. The signal processor 134 (e.g., in cooperation with the processor 111) may also apply pattern recognition and machine learning techniques to improve detection accuracy and reduce false positives. In embodiment, the signal processor 134 may be configured to cooperate with user interface 140 to provide functionality for updating the information displayed (e.g., the display information 142) with real-time information about the detection process, such as visual and audio indicators for target identification.

In embodiments, the hardware components of the user-reconfigurable metal detector 110 may include other signal processing components that enable the refining and fine tuning of the detection capabilities of the user-reconfigurable metal detector 110. For example, bandpass filters may be included within the signal conditioner 128 or elsewhere in the signal processing chain to filter the frequency range of the signals being analyzed, summation modules may be employed to combine signals from multiple sensors or detection passes, correlation modules may be utilized to compare the received signal against known patterns or signatures of different metal types, facilitating more accurate identification and classification of detected objects, etc. These signal processing components, along with others that may be integrated into the hardware components of the user-reconfigurable metal detector 110, may operate enable the user-reconfigurable metal detector 110 to perform metal detecting operations in accordance with embodiments of the present disclosure.

The input/output (I/O) module 135 may be configured to operate as a communication interface between the metal detector and external devices, such as the local installer 180. In embodiments, the I/O module 135 may include one or more interfaces configured for different communication standards and protocols. For example, a USB interface may be utilized for direct, wired connections, enabling rapid data transfer and updates. In some embodiments, the I/O module 135 may feature a Bluetooth interface, a WIFI interface, a serial comms interface, etc. In embodiments, the I/O module 135 enables the user-reconfigurable metal detector 110 to receive new configurations, feature updates, software patches, etc.

The user interface 140 may be configured to facilitate interaction between the user and the user-reconfigurable metal detector 110. In embodiments, the user interface 140 may include a screen, monitor, or display that may be configured to provide or display the display information 142, which may include a variety of operational data such as detection settings, battery life, signal strength, identification of detected metals, etc. The user interface 140 may be configured to receive inputs from the user, enabling the user to leverage the full functionality of the metal detector. Through the user interface 140, a user may customize detection parameters, adjust settings, navigate through different modes and features of the metal detector, etc. In embodiments, the user interface 140 may be configured to enable users to initiate and/or request a reconfiguration of the metal detector, in accordance with embodiments of the present disclosure. By interacting with the graphical elements on the screen, users can request modifications to the metal detector's features and/or product profiles.

It is noted that the hardware components described herein are not exhaustive and, in some embodiments, the user-reconfigurable metal detector 110 may include additional or alternative hardware components not explicitly described herein. As such, the described components are provided for illustrative purposes and exemplify the capabilities and functionality that can be leveraged from the user-reconfigurable metal detector of embodiments, and their description should not be construed as limiting in any way.

The reconfiguration manager 136 may be configured to manage the installation of a customized configuration into the user-reconfigurable metal detector 110. As described in more detail herein, the user-reconfigurable metal detector 110 may be configured with a set of features providing functionality that leverages or is derived from the functionality and capabilities of the hardware components within the user-reconfigurable metal detector 110. In embodiments, the customized configuration may include a set of features for configuring the user-reconfigurable metal detector 110, and the reconfiguration manager 136 may be configured to install the customized configuration into the user-reconfigurable metal detector 110.

In some embodiments, the reconfiguration manager 136 may be configured to facilitate communication between the user-reconfigurable metal detector 110 and the local installer 180, such as for facilitating the customizing of the configuration for the user-reconfigurable metal detector 110, validating the customized configuration, receiving files and/or code for installing the customized configuration, etc.

In embodiments, the reconfiguration manager 136 may be configured to handle the downloading of software codes and/or files that may be configured for installing the customized configuration into the user-reconfigurable metal detector 110. In embodiments, this may include retrieving the latest updates or feature sets from the local installer 180, which may operate as an intermediary between the user-reconfigurable metal detector 110 and the backend system 150. Once the appropriate software, files and/or code is downloaded, the reconfiguration manager 136 may be configured to execute the code within the user-reconfigurable metal detector 110 for installing the customized configuration, effectively transforming the functionality of the user-reconfigurable metal detector 110 in accordance with the customized configuration.

In embodiments, the process for customizing a configuration for the user-reconfigurable metal detector 110 may include the addition of new features that may operate to enhance the user-reconfigurable metal detector 110's performance or the activation of previously disabled features. For example, if a user wishes to add a particular feature, such as the “Volume Control” feature described in more detail herein, to the configuration of the user-reconfigurable metal detector 110, the reconfiguration manager 136 may be configured to manage the download of the corresponding software, files, and/or code from the local installer 180 and to execute the software, files, and/or code to integrate this feature into the user-reconfigurable metal detector 110's operation. Similarly, if a user decides to enable a “Screen Backlight” feature (e.g., described in more detail herein) that was previously disabled, the reconfiguration manager 136 may manage the execution of corresponding software, files, and/or code within the user-reconfigurable metal detector 110 to activate this feature.

In embodiments, the reconfiguration manager 136 may be configured to ensure that any software, code, and/or files downloaded to the user-reconfigurable metal detector 110 are compatible with the existing hardware and software of the user-reconfigurable metal detector 110. The reconfiguration manger 136 may perform checks and validations to confirm that the new configurations may function as intended. In the event that a configuration requires a more complex update, the reconfiguration manager 136 may coordinate with the local installer 180 to obtain the appropriate files, code, and/or software and execute it in a manner that aligns with the user-reconfigurable metal detector 110's configuration.

With reference back to FIG. 1, it is noted that the functionality of the user-reconfigurable metal detector system 100 may include functionality for creating, constructing, and/or generating a set of available features associated with the user-reconfigurable metal detector 110. In embodiments, the functionality for customizing the configuration for the user-reconfigurable metal detector 110 may include functionality for selecting one or more features from the set of available features to customize the configuration for the user-reconfigurable metal detector 110 by including the selected features in the customized configuration.

In embodiments, the set of available features may be derived from the functionality and capabilities of the hardware components within the user-reconfigurable metal detector 110. For example, in a particular example, the functionality of the transmitter 120, which may be configured to generate the transmit wave, may be managed by the functionality of the processor 111. In this example, the functionality of the transmitter 120 and the processor 111 with respect to the generation of the transmit wave may be combined to form a feature that allows users to control characteristics of the transmit wave. In particular, a feature related to the frequency of the transmit wave may be formed. This feature, which may be referred to as the “transmit wave frequency” feature, may enable configuration of the frequency of the transmit wave, and may be leveraged by the user-reconfigurable metal detector 110 to tune the user-reconfigurable metal detector 110 for different detection scenarios, such as adjusting the frequency to improve detection of small objects or to penetrate deeper into the ground.

In another example, the capabilities of the coil 122 and the receiver 124 may be combined to form a “signal analysis” feature. This signal analysis feature may leverage the coil 122's ability to detect subtle changes in the magnetic field and the receiver 124's precision in capturing the receive signal to provide detailed information about the detected metal objects. The signal analysis feature may be configured with various levels of performance, from basic metal identification to advanced discrimination settings that allow users to filter out unwanted metallic noise and focus on specific target metals.

In a further example, the functionality of the signal processor 134 may be used to form a “target characterization” feature. This feature may use the digital signal analysis capabilities of the signal processor 134 to provide users with insights into the size, shape, and composition of detected objects. In still another example, the capabilities and functionalities of the user interface 140 may be used to form a “customizable display” feature. This feature may allow users to personalize the information presented on the screen, such as selecting which detection parameters to display, customizing the layout of the interface, and choosing how target information is represented visually.

In the same manner, other features associated with the user-reconfigurable metal detector 110 may be formed leveraging the functionality, combined or individual, of the various hardware components of the user-reconfigurable metal detector 110.

In embodiments, the features formed may be included in the set of available features associated with the user-reconfigurable metal detector 110. In this manner, the set of available features associated with the user-reconfigurable metal detector 110 may represent a set of features that are available to be installed, enabled, changed, or otherwise implemented as part of the customization of the configuration for the user-reconfigurable metal detector 110. In embodiments, each feature in the set of available features associated with the user-reconfigurable metal detector 110 may represent a specific functionality provided by the arrangement or capability of one or more hardware components.

In embodiments, one or more features of the set of available features associated with the user-reconfigurable metal detector 110 may be configurable with varying levels of performance. This is in contrast with one or more one or more features of the set of available features associated with the user-reconfigurable metal detector 110 that may be configurable as either enabled or disabled, with nor varying levels of performance. The varying levels of performance may provide a spectrum of operational capabilities associated with an available feature that can be tailored to specific metal detecting requirements and/or operations. For example, an available feature that defines the number of frequencies that can be used in a multi-frequency configuration can have different levels, each offering a distinct number of frequencies to enhance detection capabilities. For example, at a first level, this available feature may include the use of 2 frequencies, at a second level this available feature may include an increased number of frequencies to 4, and at a third level this available feature may include an increased number of frequencies to 7.

In embodiments, the set of available features associated with the user-reconfigurable metal detector 110 may include features such as a “Detection Performance Comparison” feature, a “Cumulative Increased Detection Depth” feature, an “Iron Volume” feature, a “Volume Control” feature, a “Screen Backlight” feature, a “Number of Tones” feature, an “Iron Audio” feature, a “Multi-Frequency” feature, a “Number of Discrimination Modes” feature, a “Wireless Mode” feature, a “Phase Roll Target ID” feature, a “Multi-Dimensional Multi-Frequency” feature, a “Target ID Scale/Graphs” feature, a “Frequency Shift” feature, a “Pinpoint Mode” feature, a “Ground Balance” feature, a “Variable Recovery/Reactivity” feature, software-affected physical features, where software commands may enable or disable hardware components, resulting in changes to the metal detector's physical functionality. In some embodiments, the set of available features associated with the user-reconfigurable metal detector 110 may be stored in the backend system 150 and/or the local installer 180.

It is noted that the specific features described herein as part of the set of available features for the user-reconfigurable metal detector are provided for illustrative purposes and are not intended to be exhaustive or to limit the disclosure in any manner. In some embodiments, the metal detector may include additional features not explicitly discussed, which may offer further enhancements or specialized functionalities tailored to the diverse requirements of metal detecting operations.

In embodiments, customizing a configuration for the user-reconfigurable metal detector 110 may include configuring the set of features for the customized configuration, which may include selecting the features for the set of features from the set of available features associated with the user-reconfigurable metal detector 110 and/or configuring the selected features. Configuring the selected features may include configuring a performance level, activation status, etc., for each of the selected features. In embodiments, configuring the set of features for the customized configuration may include a request to one or more of downgrade, upgrade, remove, add, enable, or disable for one or more of the features in the set of features for the customized configuration.

In embodiments, customizing a configuration for the user-reconfigurable metal detector 110 may include selecting a product profile that includes a set of features selected from the set of available features with which to configure the user-reconfigurable metal detector 110. In embodiments, the selected product profile may replace the current configuration of the user-reconfigurable metal detector 110, which may include configuring the set of features with which the user-reconfigurable metal detector 110 is currently configured to match the set of features, and the configuration of each feature, of the selected product profile, and/or may include replacing a current product profile of the user-reconfigurable metal detector 110. In embodiments, features related to the creation, management, and/or installation of product profiles for configuring and/or reconfiguring the user-reconfigurable metal detector 110 may be described in related applications, the entireties of which are herein incorporated by reference for all purposes.

In embodiments, the user-reconfigurable metal detector 110 may be configured to allow a user to configure the user-reconfigurable metal detector 110 with a customized configuration. The functionality of the user-reconfigurable metal detector 110 to enable a user to configure the user-reconfigurable metal detector 110 with a customized configuration may enable the user to adapt the user-reconfigurable metal detector 110 to a variety of metal detecting scenarios without the expense and inconvenience of purchasing a new metal detector hardware. For example, a user may initially purchase a metal detector with a basic product profile suitable for general metal detecting. As the customer's interest and skill level grow, the customer may choose to customize a different configuration including features that provide higher performance, which may enable the user to unlock advanced features and enhance the metal detector's capabilities, without the need or expense of a new metal detector.

In embodiments, the functionality of the user-reconfigurable metal detector system 100 to customize and install the configuration for the user-reconfigurable metal detector 110 may be provided by the functionality of update system 105. In embodiments, the update system 105 may be configured to provide and manage the configuration customization and installation process of the user-reconfigurable metal detector system 100. As noted above, the update system 105 may include the backend system 150 and the local installer 180.

In some embodiments, the backend system 150 and the local installer 180 may cooperatively operate to provide functionality for customizing and installing configurations for the user-reconfigurable metal detector 110. For example, the backend system 150 may operate as a centralized platform that manages the set of available features associated with various reconfigurable metal detectors including the user-reconfigurable metal detector 110, that manages the set of available product profiles for the user-reconfigurable metal detector 110, that processes inputs from users related to the customization of configurations for the user-reconfigurable metal detector 110, and that authorizes and/or validates the customized configuration before the customized configuration may be installed into the user-reconfigurable metal detector 110. On the other hand, the local installer 180 may operate as an intermediary that directly interfaces with the user-reconfigurable metal detector 110, facilitating the actual installation of the customized configurations and ensuring that the user-reconfigurable metal detector 110 operates according to the user's specifications. In embodiments, there may be an overlap in the functionality provided by the backend system 150 and the local installer 180, with some features being managed by both components. In some cases, the combined operation of the backend system 150 and the local installer 180 may be leveraged to provide the customization and installation functionality, where the backend system 150 authorizes and validates the user's selections, and the local installer 180 executes the installation of the new configuration on the user-reconfigurable metal detector 110. This cooperative approach ensures that the reconfiguration process is efficient, secure, and tailored to the user's individual metal detecting requirements.

In embodiments, the backend system 130 may be configured to facilitate the customization and installation of configurations for the metal detector. In some embodiments, the backend system 150 may provide an interface (e.g., a web portal) through which users may log in to manage their metal detecting devices. This portal may operate as a centralized platform for users to view metal detecting devices (e.g., including the user-reconfigurable metal detector 110) associated with their account, register new devices, access the current configuration of associated devices, including the set of features installed and the configuration level of each feature, etc.

For example, upon logging into the portal, users may be presented with an interface that displays the current product profile of their metal detectors, providing insights into the active features and their respective settings. Users can also view a list showing the features of the set of available features associated with each metal detecting device. In embodiments, the set of available features associated with a metal detecting device represents a range of functionalities that the metal detecting device's hardware and software can support. This list includes features that can be added to enhance or modify the metal detecting device's capabilities, as well as options to remove, disable, or enable features based on the user's metal detecting requirements.

In embodiments, the backend system 150 may enable a user to customize the configuration of the user-reconfigurable metal detector 110 by enabling the user to select one or more new features from the list of available features associated with the user-reconfigurable metal detector 110 for adding to the configuration of the user-reconfigurable metal detector 110. The selected features may be added to the customized configuration that is to be installed into the user-reconfigurable metal detector 110. In this manner, the backend server may enable the user to tailor the metal detector to specific metal detecting operations. Additionally, users may select features to remove from the current configuration of the user-reconfigurable metal detector 110, and/or features of the current configuration of the user-reconfigurable metal detector 110 to disable or enable.

In embodiments, the backend system 150 may enable the user to customize the configuration of the user-reconfigurable metal detector 110 by enabling the user to select one or more features of the set of features of the current configuration of the user-reconfigurable metal detector 110 for upgrading to a higher performance level or for downgrading to a lower performance level. Upgrading a feature to a higher performance level may unlock advanced capabilities or enhance the performance of the metal detector, while downgrading a feature to a lower performance level may simplify the metal detector's functionality or revert to a previous state. The backend system 150 may processes the feature selections and may generate a customized configuration based on the selection for installing into the user-reconfigurable metal detector 110. The customized configuration may be provided to the local installer 180 for installation into the user-reconfigurable metal detector 110.

In embodiments, the backend system 150 may be configured to handle financial transactions associated with the customization process. For example, users may purchase new features or upgrades to existing features directly through the portal. The backend system 150 may processes these transactions securely, providing users with the ability to enhance their metal detector's functionality. In cases where a user decides to remove a feature or downgrade to a simpler version, the backend system 150 is capable of processing refunds, offering users financial flexibility and the opportunity to trial features before making a permanent decision.

It is noted that in some cases, the backend system 150's functionality to enable customization of a configuration for the user-reconfigurable metal detector 110 may include functionality to enable the user to select a new product profile including a set of features to replace the current product profile of the user-reconfigurable metal detector 110. In this case, after installation of the new product profile, the set of features of the new product profile may replace the set of features of the current product profile. In some embodiments, the set of features of the new product profile may include a different set of features (e.g., more or less features) from the set of features of the current product profile. In some embodiments, one or more features of the new product profile may be configured at a particular level of performance.

At this point it is noted that the customized configuration for the user-reconfigurable metal detector 110 may be configured to support or enable a particular classification of metal detecting operations. These classifications may include performance-based operations or application-based operations, each tailored to meet specific metal detecting goals and scenarios. For example, performance-based operations may include configurations that enhance the metal detector's capabilities, such as increased detection depth, improved discrimination accuracy, or enhanced sensitivity to small or low-conductivity targets. Customizing a configuration to support a performance-based operation provides users with a higher level of performance, enabling them to detect targets more effectively and efficiently.

Application-based operations, on the other hand, may include configurations that are optimized for specific metal detecting applications. For example, a customized configuration may include a set of features configured to support beach metal detecting, which may include features such as saltwater immunity and sand penetration. Another customized configuration may be configured to support or enable relic hunting, emphasizing features that aid in the detection of historical artifacts, such as advanced ground balancing and iron discrimination. By including features and/or configuring the features to align with a particular application, users may ensure that the user-reconfigurable metal detector 110 is configured with the appropriate set of features, at the appropriate level of performance, to operate efficiently and effectively in the particular operation.

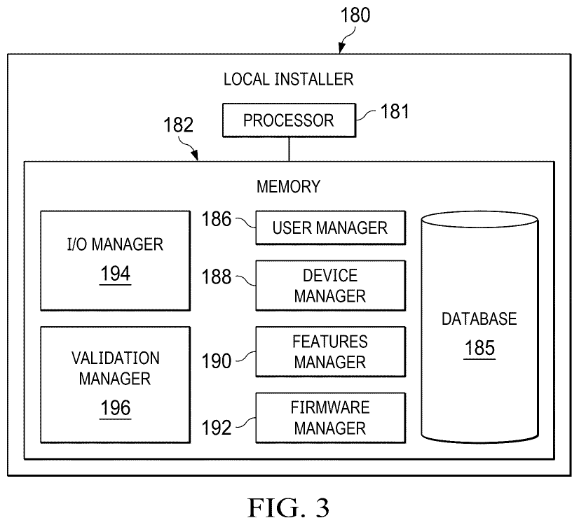

In embodiments, the local installer 180 may be configured to operate as an intermediary between the backend system 150 and the user-reconfigurable metal detector 110 to manage operations related to the customization and installation of configurations for the user-reconfigurable metal detector 110. The functionality of the local installer 180 will now be discussed with reference to FIG. 3. FIG. 3 is a block diagram of an exemplary local installer 180 configured with capabilities and functionality for customizing and installing a configuration for a user-reconfigurable metal detector in accordance with embodiments of the present disclosure.

It is noted that the functional blocks, and components thereof, of the local installer 180 illustrated in FIG. 3 may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of the local installer 180 illustrated in FIG. 3 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of the local installer 180 illustrated in FIG. 3 described herein is provided for purposes of illustration, rather than by way of limitation and that functionalities described as being provided by different functional blocks may be combined into a single component or may be provided via computing resources disposed in a cloud-based environment accessible over a network.

As shown in FIG. 3, the local installer 180 may include processor 181, memory 182, user manager 186, device manager 188, features manager 190, firmware manager 192, I/O manager 194, validation manager 196, and database 185. The processor 181 may comprise a processor, a microprocessor, a controller, a microcontroller, a plurality of microprocessors, an ASIC, an ASSP, or any combination thereof, and may be configured to execute instructions to perform operations in accordance with the disclosure herein. In some embodiments, implementations of the processor 181 may comprise code segments (e.g., software, firmware, and/or hardware logic) executable in hardware, such as a processor, to perform the tasks and functions described herein. In yet other embodiments, the processor 181 may be implemented as a combination of hardware and software. The processor 181 may be communicatively coupled to the memory 182.

The memory 182 may comprise one or more semiconductor memory devices, ROM devices, RAM devices, one or more HDDs, flash memory devices, SSDs, EROM, CD-ROM, optical disks, other devices configured to store data in a persistent or non-persistent state, network memory, cloud memory, local memory, or a combination of different memory devices. The memory 182 may comprise a processor readable medium configured to store one or more instruction sets (e.g., software, firmware, etc.) which, when executed by a processor (e.g., one or more processors of the processor 181), perform tasks and functions as described herein.

The memory 182 may also be configured to facilitate storage operations. For example, the memory 182 may comprise a database 185 for storing various information related to operations of the local installer 180. For example, the database 185 may store various types of information related to the user-reconfigurable metal detector 110. This information may include identification details of the user-reconfigurable metal detector 110, such as its serial number, model number, and other identifiers that uniquely distinguish the device. In embodiments, the database 185 may store the set of available features associated with the user-reconfigurable metal detector 110. This set of available features may represent a range of functionalities that the user-reconfigurable metal detector 110's hardware and software can support, including features that can be added to enhance the user-reconfigurable metal detector 110's capabilities, as well as options to remove, disable, or enable features based on the user's metal detecting requirements. Additionally, the database 185 may maintain information about the current configuration of the metal detector 110, such as the current set of features and/or the current product profile. This may include details about the configuration of each feature, such as the level of performance with which one or more features may be configured. In embodiments, the database 185 may store user profiles, purchase history, and device configurations, which may facilitate a personalized and efficient customization and installation experience. The database 185 may also store logs of user interactions, reconfiguration requests, and the status of any pending or completed updates or modifications.

The database 185 is illustrated as integrated into the memory 182, but in some embodiments, the database 185 may be provided as a separate storage module or may be provided as a cloud-based storage module. Additionally, or alternatively, the database 185 may be a single database, or may be a distributed database implemented over a plurality of database modules.

The user manager 186 may be configured to manage user-related functionality within the local installer 180. In embodiments, the user manager 186 may be configured to identify a user during the login process, ensuring secure access to the functionality of the local installer 180. For example, the user manager 186 may receive credentials from the user and may verify the credentials against stored user account details within the database 185, which may include usernames, passwords, and other authentication data. Alternatively, the user manager 186 may verify the credentials using the functionality of the backend system 150.

Once a user is authenticated, the user manager 186 may query the backend system 150 for information related to the user's account. This information may include a variety of user-specific data such as registered devices, purchased features, product profiles associated with the user, etc. In this manner, the user manager 186 may enable users to view and manage their metal detecting devices, track their purchase history, and access the current configuration of associated devices.

In embodiments, the user manager 186 may be configured to enable users to update their account details, manage their device registrations, and receive notifications about new features or updates available for their metal detectors. The user manager 186 may also log user interactions and reconfiguration requests.

The device manager 188 may be configured to manage device-related functionality of the local installer 180. In embodiments, the device manager 188 may be configured to obtain and maintain detailed information related to the user-reconfigurable metal detector 110. This information may include identity information such as the user-reconfigurable metal detector 110's serial number, model number, and other identifiers that uniquely distinguish the user-reconfigurable metal detector 110 within the system.

In embodiments, the device manager 188 may be configured to obtain configuration information from the user-reconfigurable metal detector 110, which may include the current product profile, the set of features currently enabled, and/or any custom settings that have been applied by the user. This configuration information can be used to ensure that any configuration customizations are compatible with the user's preferences and the user-reconfigurable metal detector 110's capabilities.

In some embodiments, the device manager 188 may interact with the database 185 to store and retrieve the configuration information of the user-reconfigurable metal detector 110. This interaction may enable the customization process, as the device manager 188 may provide access to the relevant information to facilitate feature modifications in the customized configuration. Additionally, the device manager 188 may be configured to manage the registration of new devices, ensuring that they are properly integrated into the user's account and the system as a whole.

In some embodiments, the device manager 188 may be configured to monitor the status of the user-reconfigurable metal detector 110, including tracking the installation of customized configurations, including the installation of new features or product profiles, and logging any modification requests made by the user.

The features manager 190 may be configured to manage functionality related to the set of available features associated with the user-reconfigurable metal detector 110. For example, in some embodiments, the features manager 190 may be configured to obtain (e.g., from the backend server 150) a list of available features that the user-reconfigurable metal detector 110's hardware and software can support. This list may include a range of functionalities, from basic operational modes to advanced detection capabilities, which can be added to modify the metal detector's performance or to tailor the user-reconfigurable metal detector 110 to specific metal detecting applications.

In embodiments, the features manager 190 may operate in conjunction with the I/O manager 194 to present the list of available features associated with the user-reconfigurable metal detector 110 to the user. In embodiments, this presentation may be facilitated through the user interface of the local installer 180, which may be accessed via the user terminal 130. In some embodiments, the list of available features may be presented alongside the current set of features of the user-reconfigurable metal detector 110, which may provide users with a clear indication of which features are included in the current configuration and which are not. This comparative display may enable users to easily identify potential enhancements or additional functionalities that they may wish to incorporate into their metal detector.

In embodiments, the features manager 190 may be configured to indicate the available levels for features that are configurable at different levels of performance. For example, a feature such as the Multi-Frequency feature may be presented with options for two, four, or more frequencies, each level offering a different degree of detection capability. By providing this information, the features manager 190 may enable users to make informed decisions about upgrading or customizing the user-reconfigurable metal detector 110's features based on their specific requirements and the complexity of the metal detecting environments they encounter.

The functionality of the features manager 190 to provide the list of available features associated with the user-reconfigurable metal detector 110 and the current configuration of the user-reconfigurable metal detector 110 may enable customization of a configuration for the user-reconfigurable metal detector 110, as the user may (e.g., through the interface provide by the local installer 180) select one or more features from the list of available features to be added to the customized configuration, select one or more features from the current set of features of the current configuration of the user-reconfigurable metal detector 110 for removal from the current set of features, select one or more features from the current set of features of the current configuration of the user-reconfigurable metal detector 110 to be disabled, select one or more features from the current set of features of the current configuration of the user-reconfigurable metal detector 110 to be enabled, select one or more features from the current set of features of the current configuration of the user-reconfigurable metal detector 110 for upgrading to a higher performance level, select one or more features from the current set of features of the current configuration of the user-reconfigurable metal detector 110 for downgrading to a lower performance level, and/or select a new product profile including a set of features for replacing the current product profile of the user-reconfigurable metal detector 110.

In embodiments, the features manager 190 may be configured to perform operations for managing the installation of the customized configuration into the user-reconfigurable metal detector 110. For example, after a configuration for the user-reconfigurable metal detector 110 is customized, which may involve selecting features to include, upgrade, downgrade, remove, enable, or disable, and/or selecting a product profile to install, the features manager 190 may manage the installation of the customized configuration into the user-reconfigurable metal detector 110.

In some embodiments, before the installation of the customized configuration, the features manager 190 may work in conjunction with the validation manager 196 to validate the customized configuration. This validation step represents a safeguard to ensure that the customized configuration (e.g., including features, feature upgrades, and/or selected product profiles) is authorized for use (e.g., has been purchased and/or is free to use). For example, in embodiments, the validation manager 196 may checks the user's account for purchase history and may confirm that the selected features or product profiles have been acquired legitimately.

In embodiments, the functionality of the validation manager 196 to validate the customized configuration may include functionality to query the user-reconfigurable metal detector 110 for a secret. In embodiments, this secret may include a secure identifier that may include a code, an ID, a cryptographic certificate, or any other form of data that is uniquely associated with the user-reconfigurable metal detector 110 combined with a code, ID, cryptographic certificate, or any other form of data that is uniquely associated with the feature or product profile associated with the customized configuration (e.g., the feature(s) added to the customized configuration, the features upgrade(s) in the customized configuration, selected product profiles for the customized configuration, etc.). For example, in embodiments, the secret may be a composite identifier formed from the user-reconfigurable metal detector 110's ID combined with an ID that is related to the feature or product profile associated with the customized configuration.

Upon receiving the secret from the user-reconfigurable metal detector 110, the validation manager 196 may forward this information to the backend system 150. The backend system 150 may be configured to transform the secret into a validation key. This validation process involves the backend system 150 applying a set of algorithms or cryptographic methods to the secret to generate a digital signature or token that serves as the validation key. The validation key is then validated by the backend system 150.

If the validation is successful and the validation key is deemed valid, it signifies that the feature or product profile associated with the customized configuration has been authorized for the metal detector (e.g., has been purchased or is free). Consequently, the backend system 150 may send a signal to the validation manager 196 to proceed with the installation of the customized configuration. Conversely, if the validation key is deemed invalid, this may signify that the feature or product profile associated with the customized configuration has not been authorized for the user-reconfigurable metal detector 110 (e.g., has not been purchased and is not free). In such a case, the backend system 150 may send a failure signal to the validation manager 196, in which case the validation manager may not validate the customized configuration and the installation of the customized configuration may not proceed.

In some embodiments, before the installation of the customized configuration, the features manager 190 may work in conjunction with the firmware manager 192 to ensure that the firmware of user-reconfigurable metal detector 110 is compatible with the customized configuration. The firmware manager 192 may check the current firmware version against the requirements of the new configuration. If an update is deemed necessary, the firmware manager 192 may prevent the installation of the customized configuration until the firmware update has been completed. In embodiments, the firmware manager 192 may facilitate the download and installation of the latest firmware version.

Once the customized configuration has been validated and the firmware compatibility has been confirmed, the features manager 190 may proceeds with the installation. Installation of the customized configuration into the user-reconfigurable metal detector 110 may include downloading code, software, and/or files to the user-reconfigurable metal detector 110 configured to install the customized configuration, updating software modules, activating new features, and/or integrating the selected product profile into the user-reconfigurable metal detector 110's operating system.

The I/O manager 194 may be configured to provide the communications interface that facilitates interaction and communication between the user-reconfigurable metal detector 110 and the local installer 180. In some embodiments, the I/O manager 194 may include a variety of interfaces to accommodate different communication standards and protocols, such as USB, Bluetooth, WIFI, or serial communications. These interfaces may enable the local installer 180 to establish a secure and reliable connection with the user-reconfigurable metal detector 110, allowing for the transfer of data, software updates, and installation commands.

In embodiments, the I/O manager 194 may be configured to provide the user interface that enables the user to interact with the functionality of the local installer 180 for customizing a configuration for the user-reconfigurable metal detector 110. This user interface may be accessed via the user terminal 130 and may be structured to present the user with options for customizing the metal detector, such as selecting new features, managing existing features, and installing product profiles.

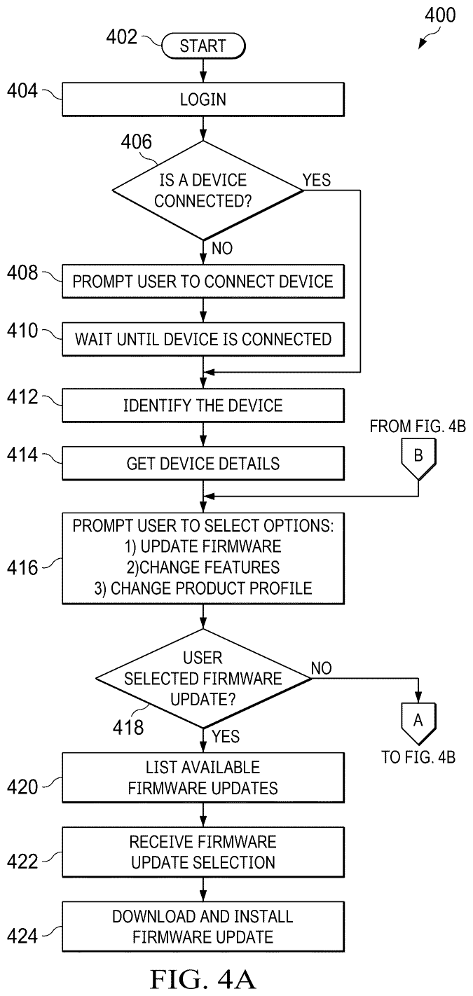

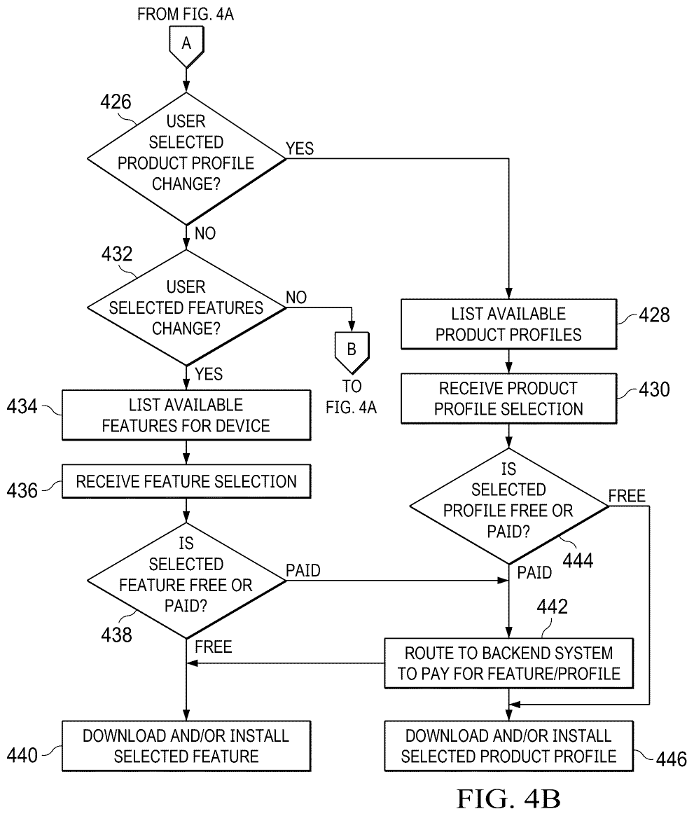

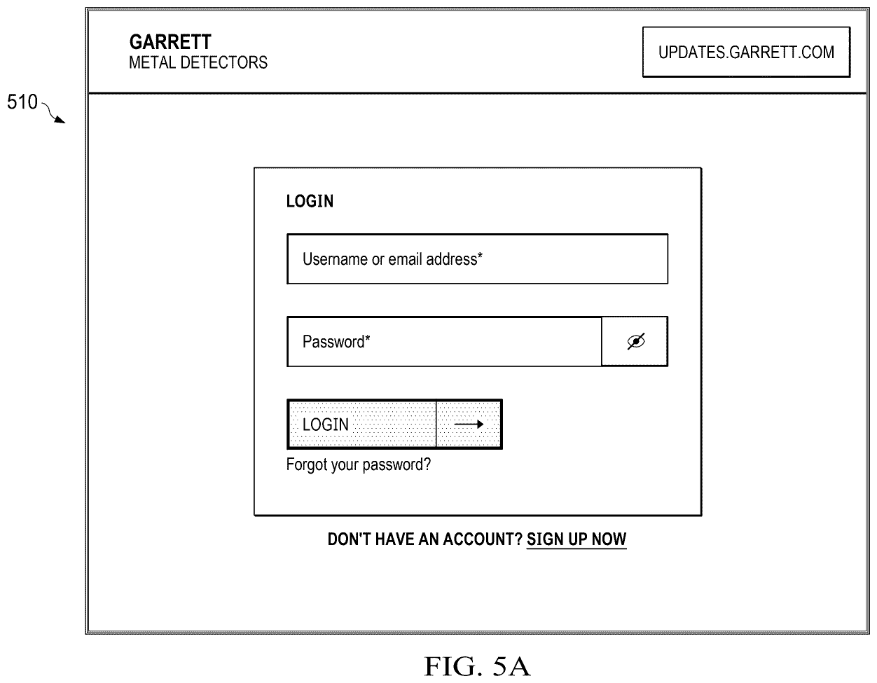

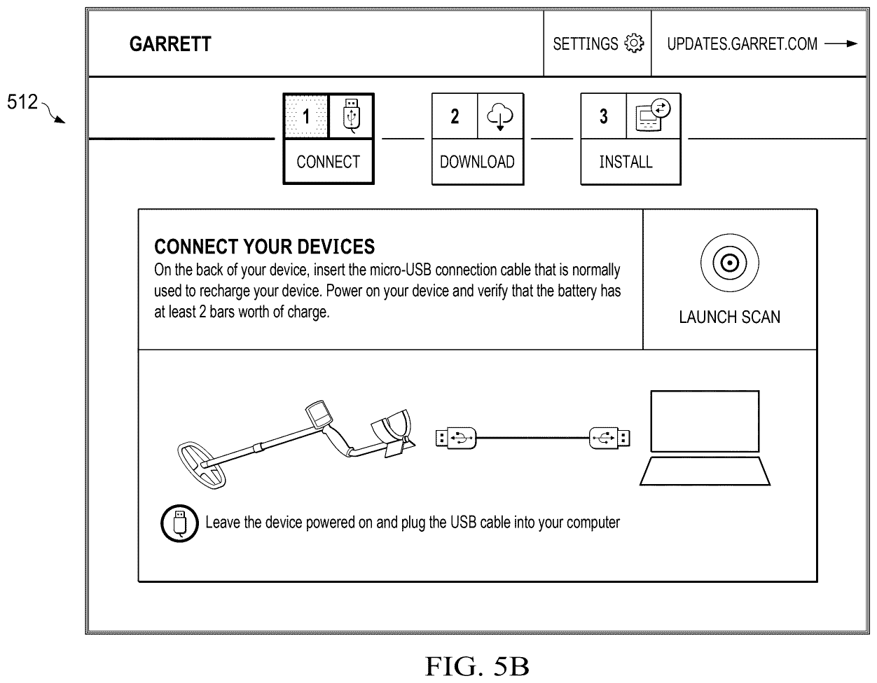

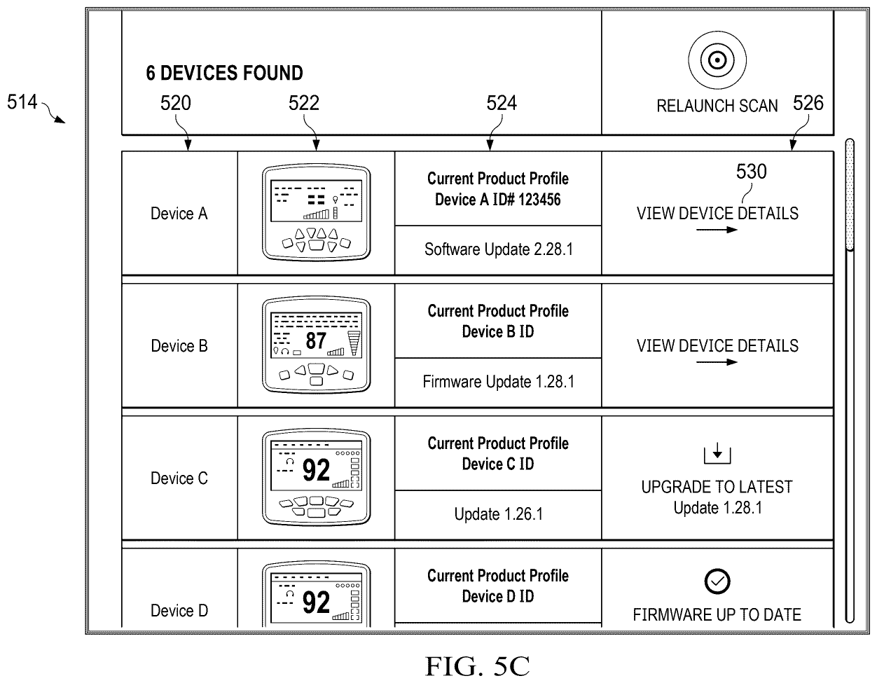

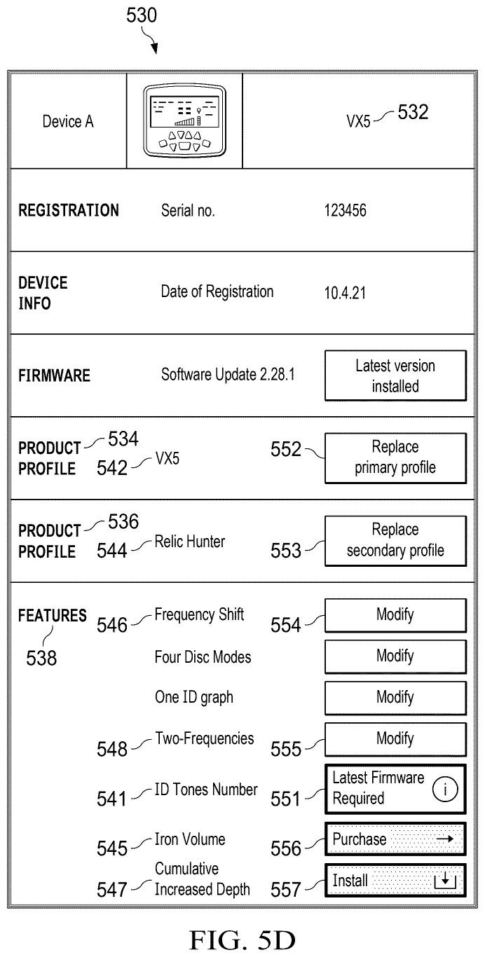

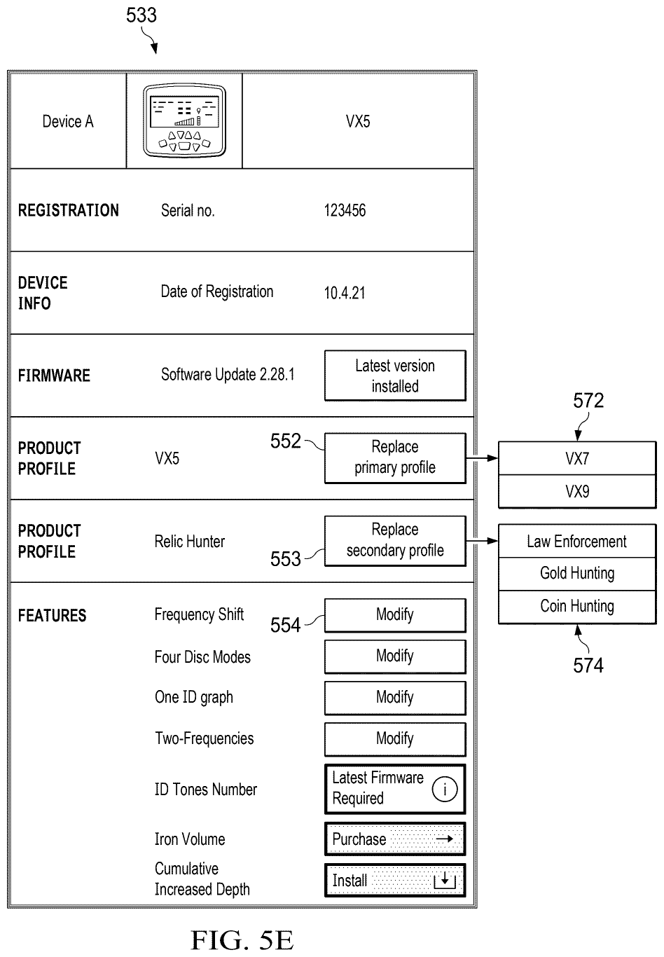

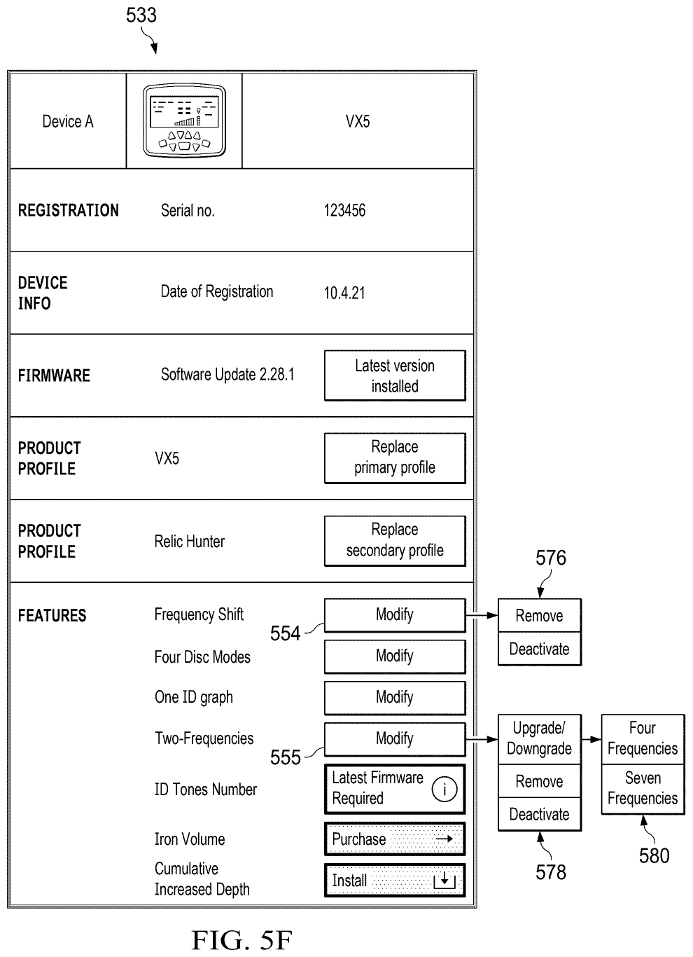

FIGS. 4A and 4B show a high-level flow diagram 400 of operation of a system configured for providing functionality for customizing and installing a configuration for a user-reconfigurable metal detector in accordance with embodiments of the present disclosure. The operations depicted in the high-level flow diagram 400 outline the steps taken by a local installer (e.g., local installer 180) to enable customization and installation of a configuration for a user-reconfigurable metal detector. The operations illustrated in FIGS. 4A and 4B will be described with further reference to FIGS. 5A-5F. FIGS. 5A-5F show diagrams illustrating operations to customize and install a configuration for a user-reconfigurable metal detector in accordance with embodiments of the present disclosure.

Operations may begin at block 402, and at block 404 a user interface provides a GUI for a user to log into the local installer 180. FIG. 5A illustrates GUI 510, which may represent this GUI for enabling the user to log in. This login step may be particularly important as it may establish the user's identity and may grant access to the metal detector's customization options.

At block 406, a determination is made as to whether a metal detecting device is connected to the local installer. If the local installer determines that no metal detecting device is connected, then the local installer may prompt, at block 408, for the user to connect a metal detecting device, and the local installer may wait, at step 410 until a metal detecting device is connected to the local installer. In embodiments, connecting a metal detecting device to the local installer may include connecting the metal detecting device to the computing device (e.g., the user terminal) in which the local installer is being hosted (e.g., local terminal 130 in some embodiments). The connection may be established over a USB protocol, Bluetooth, WIFI, serial comms, etc. FIG. 5B illustrates GUI 512 including a prompt instructing the user to connect a metal detecting device to the user terminal hosting the local installer.

Once a metal detecting device has been connected to the computing device hosting the local installer, the local installer may establish communications with the metal detecting device.

At block 412, once communications have been established between the local installer and the metal detecting device, the identify the metal detecting device may be obtained. For example, the local installer may retrieve the metal detecting device's identification details, such as the serial number and model number, to ensure that the correct d metal detecting device is being managed.

At block 414, the local installer may retrieve the metal detecting device's details. The metal detecting device's details may include information related to the current configuration of the metal detecting device, such as the current firmware version of the metal detecting device, the current set of features with which the metal detecting device is configured, the configuration of configurable features of the current set of features with which the metal detecting device is configured, the current product profile of the metal detecting device, etc.

At block 416, a prompt is provided to enable the user to select one of several options for customizing the configuration of a metal detecting device. In a particular embodiment, the selectable options may include an option to update the firmware of the metal detecting device, an option to change one or more features associated with the metal detecting device, and an option to change the product profile of the metal detecting device.

For example, FIG. 5C illustrates a GUI 514 configured to present information related to the user's registered devices, as well as details specific to each device. For example, column 520 may provide a listing of the different devices that the user has registered with the system, offering a quick reference to all the user's metal detecting devices. Column 522 may be configured to provide a graphical representation of the devices, giving a visual cue to the user of the corresponding device appearance. Column 524 may be configured to provide an overview of each device's configuration, which may include the current product profile, active features, and an overview of the version of the firmware of each metal detecting device. This overview allows the user to quickly assess the operational status and capabilities of each registered metal detecting device. Column 526 may be configured to display the firmware status of each device, indicating whether the device is up to date with the latest software or if an update is available. When a firmware update is available, the message indicating that the update is available may be configured as a selectable element allowing the user to select it to initiate a firmware update. In this manner, the selectable element in GUI 514 for updating the firmware when available may represent the selectable option to update the firmware at block 416.

In addition, column 526 may include a selectable option to customize the configuration of a metal detecting device. For example, element 530 may include a button or link that, when activated by the user, enables the user to access a more detailed view of the device details for a specific device, in this example device A. This detailed view may include in-depth information about device A's currently configured features, current product profile, and a list of available features associated with device A.

For example, upon selection of element 530, the GUI 533 may be presented to the user. The GUI 533 may include several graphical elements for displaying information related to the corresponding device, in this example device A. For example, the information related to device A may include a serial number of the device A, a date of registration, the current firmware version, a current product profile 534 (e.g., which in this example the current product profile is product profile 542), as well as the list of available features 538 associated with the device including indications of features that are currently included in the configuration of device A. In this example, a selectable element 552 may be provided to request a replacement of the current product profile 544. In this example, the selectable element 552 in GUI 533 for replacing the current product profile of the metal detecting device may represent the selectable option to change the current product profile of the metal detecting device at block 416.

GUI 533 may include a selectable element for each feature of the list of available features 538 to request a change of the corresponding feature. In this example, the selectable element for each feature of the list of available features 538 to request a change of the corresponding feature in GUI 533 may represent the selectable option to change one or more features associated with the metal detecting device at block 416.

For example, the selectable element for a feature that is included in the current configuration of the metal detecting device may allow the user to request a modification of the feature. For example, the selectable element 554 for feature 546, which is included in the current configuration of the metal detecting device, may enable the user to request a modification of the feature 546. The selectable element for a feature that is not included in the current configuration of the metal detecting device may allow the user to request that the feature be added to the current configuration of the metal detecting device. For example, features 541, 545, and 547 are indicated as not being included in the current configuration of device A. In this case, any of these features may be requested to be added to the current configuration of device A using the corresponding selectable element. For example, feature 545 may be requested to be added by selecting selectable element 556, which may require the user to purchase the feature before the feature can be added to the current configuration of device A. Feature 547 may be requested to be added by selecting selectable element 557, which may not require the user to purchase the feature 547, as the feature may have been previously purchased or may be free. Feature 541 may be requested to be added by selecting selectable element 551, which may require the user to update the device A's firmware before the feature 541 can be added to the current configuration of device A.

At block 418, a determination is made as to whether the user has selected the selectable option to update the firmware of the metal detecting device. In response to a determination that the user has selected the selectable option to update the firmware of the metal detecting device, the available firmware updates are presented to the user (e.g., via GUI 514 of FIG. 5C) at block 420. At block 422, a firmware update selection is received. For example, the user may select a firmware update for installation into the metal detecting device and may confirm the installation of the firmware update. At block 424, the selected firmware update is downloaded and/or installed into the metal detecting device.

In response to a determination that the user has not selected the selectable option to update the firmware of the metal detecting device, a determination is made, at block 426, as to whether the user has selected the selectable option to change the product profile of the metal detecting device.

In response to a determination that the user has selected the selectable option to change the product profile of the metal detecting device, the list of available product profiles for the metal detecting device may be presented to the user at block 428. For example, as shown in FIG. 5E, the user may select selectable element 552 to request to change the current product profile 542 (e.g., a product profile termed VX5 in this example) of device A. In response to the user selecting selectable element 552, list 572 may be presented to the user. List 572 may include the available product profiles for device A including a VX7 product profile, which may represent a higher level of performance than the VX5 product profile, and a VX9 product profile, which may represent a higher level of performance than the VX7 product profile.

In some embodiments, a metal detecting device may be configured to support a primary product profile and a secondary product profile. In some embodiments, the primary and secondary product profiles may be configured to support different classifications of metal detecting operations. For example, in a particular configuration, such as the one for device A as illustrated in FIG. 5E, the primary product profile may be configured to support performance-based classifications of metal detecting operations. For example, the available product profiles for the primary product profile may be configured with different levels of performance. In this example, the secondary product profile 544 may be configured to support application-based classifications of metal detecting operations. For example, the available product profiles for the secondary product profile may be configured for different metal detecting applications, such as law enforcement, fold hunting, coin hunting, etc., as shown in menu 574, but may include many other application-based product profiles.

The user may select one of the listed product profiles. The product profile selection may be received by the local installer at block 430, and at block 444, a determination is made as to whether the selected product profile is free or requires purchase. In the case where the selected product profile is free, or has been previously purchased, the operations proceed to block 446 at which the selected profile is downloaded, if required, and/or installed into device A in accordance with embodiment the present disclosure. As noted, the new product profile may include a set of features that may represent a higher performance than the performance provided by the VX5 product profile.

However, in response to a determination that the selected product profile is not free or has not been previously purchased, and requires payment, the local installer may route, at block 442, the request to install the selected product profile to the backend system 150, which may be configured to allow the user to purchase the selected product profile. Once payment is successfully received, operations may proceed to block 446 at which the selected profile is downloaded, if required, and/or installed into device A in accordance with embodiment the present disclosure.

Referring back to block 426, in response to a determination that the user has not selected the selectable option to change the product profile of the metal detecting device, a determination is made, at block 432, as to whether the user has selected the selectable option to change one or more features associated with the metal detecting device. In response to a determination that the user has not selected the selectable option to change one or more features associated with the metal detecting device, operations may return to block 416 where the selectable options prompt is presented to continue waiting for a user selection.

In response to a determination that the user has selected the selectable option to change one or more features associated with the metal detecting device, the list of available features for the metal detecting device may be presented to the user at block 434. For example, after selecting the selectable element 530, the user may be presented with GUI 533 including a list of available features 538. The list of available features 538 may include the features available for device A. In this case, the user may be able to request change for a particular feature by selecting the corresponding selectable element. For example, as shown in FIG. 5F, the user may select selectable element 554 to request a change to feature 546. In response to selecting selectable element 554, menu 576 is presented including available change options for feature 546. In this case, feature 546 is a Frequency Shift feature, which is not configurable to different levels of performance. As such, the change options available for feature 546 may include removal or disabling, since feature 546 is currently enabled. In the case where feature 546 is currently disabled, the available change options may include removal or enabling. In this case, the user may select one of the change options for feature 546.

As also shown in FIG. 5F, the user may select selectable element 555 to request a change to feature 548. In response to selecting selectable element 555, menu 578 is presented including available change options for feature 548. In this case, feature 548 is a Multi-Frequency feature, which is configurable to different levels of performance. Currently, feature 548 is configured to utilize two frequencies. As such, the change options available for feature 546 may include removal, disabling, and an upgrade/downgrade option. In this example, selecting the upgrade/downgrade option may present menu 580 enabling the user to specify whether feature 548 is to be upgrade or downgrade. Downgrading feature 548 may include decreasing the number of frequencies used, whereas upgrading feature 548 may include increasing the number of frequencies used for higher performance. In this case, the user may select one of the change options for feature 548.

The feature change selection may be received by the local installer at block 436, and at block 438, a determination is made as to whether the selected feature change is free or requires purchase. For example, adding a new feature or upgrading an existing feature may require purchasing the new feature or feature upgrade. In some case, the new feature or feature upgrade may have been previously purchased or may be free, in which case no purchase is required. In the case where the selected feature change is free, or has been previously purchased, the operations proceed to block 440 at which the selected feature change is downloaded, if required, and/or installed into device A in accordance with embodiment the present disclosure.

However, in response to a determination that the selected feature change is not free or has not been previously purchased, and requires payment, the local installer may route, at block 442, the selected feature change request to the backend system 150, which may be configured to allow the user to purchase the selected feature change. Once payment is successfully received, operations may proceed to block 440 at which the selected feature change is downloaded, if required, and/or installed into device A in accordance with embodiment the present disclosure.

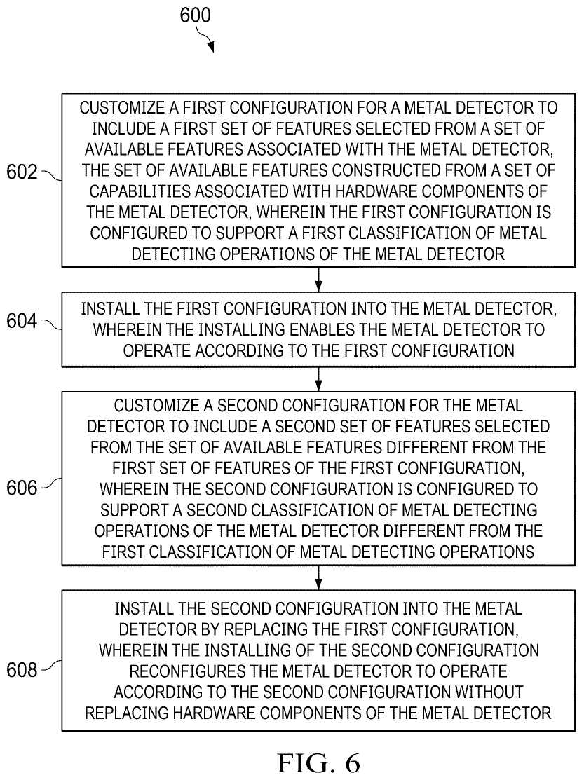

FIG. 6 shows a high-level flow diagram 600 of operation of a system configured for providing functionality for customizing and installing a configuration for a user-reconfigurable metal detector in accordance with embodiments of the present disclosure. For example, the functions illustrated in the example blocks shown in FIG. 6 may be performed by system 100 of FIG. 1 according to embodiments herein. In embodiments, the operations of the method 600 may be stored as instructions that, when executed by one or more processors, cause the one or more processors to perform the operations of the method 600.

At block 602, a first configuration for a metal detector is configured to include a first set of features selected from a set of available features associated with the metal detector. In embodiments, the set of available features is constructed from a set of capabilities associated with hardware components of the metal detector, and the first configuration is configured to support a first classification of metal detecting operations of the metal detector. In embodiments, functionality of an update system (e.g., update system 105 as illustrated in FIG. 1) may be used to customize a first configuration for a metal detector to include a first set of features selected from a set of available features associated with the metal detector. In embodiments, the update system may perform operations to customize a first configuration for a metal detector to include a first set of features selected from a set of available features associated with the metal detector according to operations and functionality as described above with reference to update system 105 and as illustrated in FIGS. 1-5F.

At block 604, the first configuration is installed into the metal detector. In embodiments, the installing enables the metal detector to operate according to the first configuration. In embodiments, functionality of a local installer (e.g., local installer 180 as illustrated in FIG. 1) may be used to install the first configuration into the metal detector. In embodiments, the local installer may perform operations to install the first configuration into the metal detector according to operations and functionality as described above with reference to local installer 180 and as illustrated in FIGS. 1-5F.

At block 606, a second configuration for the metal detector is configured to include a second set of features selected from the set of available features different from the first set of features of the first configuration. In embodiments, the second configuration is configured to support a second classification of metal detecting operations of the metal detector different from the first classification of metal detecting operations. In embodiments, functionality of an update system (e.g., update system 105 as illustrated in FIG. 1) may be used to customize a second configuration for the metal detector to include a second set of features selected from the set of available features different from the first set of features of the first configuration. In embodiments, the update system may perform operations to customize a second configuration for the metal detector to include a second set of features selected from the set of available features different from the first set of features of the first configuration according to operations and functionality as described above with reference to update system 105 and as illustrated in FIGS. 1-5F.

At block 608, the second configuration is installed into the metal detector by replacing the first configuration. In embodiments, the installing of the second configuration reconfigures the metal detector to operate according to the second configuration without replacing hardware components of the metal detector. In embodiments, functionality of a local installer (e.g., local installer 180 as illustrated in FIG. 1) may be used to install the second configuration into the metal detector by replacing the first configuration. In embodiments, the local installer may perform operations to install the second configuration into the metal detector by replacing the first configuration according to operations and functionality as described above with reference to local installer 180 and as illustrated in FIGS. 1-5F.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112 (f). Even under the broadest reasonable interpretation, in light of this paragraph of this specification, the claims are not intended to invoke 35 U.S.C. § 112 (f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of customizing and installing a configuration for a metal detector, comprising:
customizing a first configuration for a metal detector to include a first set of features selected from a set of available features associated with the metal detector, the set of available features constructed from a set of capabilities associated with hardware components of the metal detector, wherein the first configuration is configured to support a first classification of metal detecting operations of the metal detector;
installing the first configuration into the metal detector, wherein the installing enables the metal detector to operate according to the first configuration;
customizing a second configuration for the metal detector to include a second set of features selected from the set of available features different from the first set of features of the first configuration, wherein the second configuration is configured to support a second classification of metal detecting operations of the metal detector different from the first classification of metal detecting operations; and
installing the second configuration into the metal detector by replacing the first configuration, wherein the installing of the second configuration reconfigures the metal detector to operate according to the second configuration without replacing hardware components of the metal detector.

2. The method of claim 1, wherein customizing the first configuration for the metal detector includes one or more of:
selecting features from the set of available features to include in the first set of features;
selecting a configuration for features selected for inclusion in the first set of features that are that are configurable to different performance levels, the configuration defining a selected performance level;
selecting features from the set of available features to exclude from the first set of features; and
selecting features from the first set of features to enable or to disable.

3. The method of claim 1, wherein customizing the first configuration for the metal detector includes selecting a product profile that includes the first set of features, wherein the product profile is configured to support the first classification of metal detecting operations of the metal detector.

4. The method of claim 1, wherein customizing the second configuration for the metal detector further includes selecting a product profile that includes the second set of features, wherein the product profile is configured to support the second classification of metal detecting operations of the metal detector.

5. The method of claim 1, wherein the second configuration includes upgraded versions of one or more features from the first set of features of the first configuration, wherein the upgraded versions provide enhanced performance levels compared to those in the first configuration.

6. The method of claim 1, wherein the second configuration includes downgraded versions of one or more features from the first set of features of the first configuration, wherein the downgraded versions provide lower performance levels compared to those in the first configuration.

7. The method of claim 1, wherein the first classification of metal detecting operations is based on a performance level of the metal detector, and wherein the second classification of metal detecting operations represents a different performance level achieved by the second configuration for the metal detector, the different performance level providing one of higher detection capabilities or lower detection capabilities compared to the first classification.

8. The method of claim 1, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.

9. A system configured for customizing and installing a configuration for a metal detector, comprising:
at least one processor; and
a memory operably coupled to the at least one processor and storing processor-readable code that, when executed by the at least one processor, is configured to perform operations including:
customizing a first configuration for a metal detector to include a first set of features selected from a set of available features associated with the metal detector, the set of available features constructed from a set of capabilities associated with hardware components of the metal detector, wherein the first configuration is configured to support a first classification of metal detecting operations of the metal detector;
installing the first configuration into the metal detector, wherein the installing enables the metal detector to operate according to the first configuration;
customizing a second configuration for the metal detector to include a second set of features selected from the set of available features different from the first set of features of the first configuration, wherein the second configuration is configured to support a second classification of metal detecting operations of the metal detector different from the first classification of metal detecting operations; and
installing the second configuration into the metal detector by replacing the first configuration, wherein the installing of the second configuration reconfigures the metal detector to operate according to the second configuration without replacing hardware components of the metal detector.

10. The system of claim 9, wherein customizing the first configuration for the metal detector includes one or more of:
selecting features from the set of available features to include in the first set of features;
selecting a configuration for features selected for inclusion in the first set of features that are that are configurable to different performance levels, the configuration defining a selected performance level;
selecting features from the set of available features to exclude from the first set of features; and
selecting features from the first set of features to enable or to disable.

11. The system of claim 9, wherein customizing the first configuration for the metal detector includes selecting a product profile that includes the first set of features, wherein the product profile is configured to support the first classification of metal detecting operations of the metal detector.

12. The system of claim 9, wherein customizing the second configuration for the metal detector further includes selecting a product profile that includes the second set of features, wherein the product profile is configured to support the second classification of metal detecting operations of the metal detector.

13. The system of claim 9, wherein the second configuration includes upgraded versions of one or more features from the first set of features of the first configuration, wherein the upgraded versions provide enhanced performance levels compared to those in the first configuration.

14. The system of claim 9, wherein the second configuration includes downgraded versions of one or more features from the first set of features of the first configuration, wherein the downgraded versions provide lower performance levels compared to those in the first configuration.

15. The system of claim 9, wherein the first classification of metal detecting operations is based on a performance level of the metal detector, and wherein the second classification of metal detecting operations represents a different performance level achieved by the second configuration for the metal detector, the different performance level providing one of higher detection capabilities or lower detection capabilities compared to the first classification.

16. The system of claim 9, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.

17. A computer-based tool for customizing and installing a configuration for a metal detector, the computer-based tool including non-transitory computer readable media having stored thereon computer code which, when executed by a processor, causes a computing device to perform operations comprising:
customizing a first configuration for a metal detector to include a first set of features selected from a set of available features associated with the metal detector, the set of available features constructed from a set of capabilities associated with hardware components of the metal detector, wherein the first configuration is configured to support a first classification of metal detecting operations of the metal detector;
installing the first configuration into the metal detector, wherein the installing enables the metal detector to operate according to the first configuration;
customizing a second configuration for the metal detector to include a second set of features selected from the set of available features different from the first set of features of the first configuration, wherein the second configuration is configured to support a second classification of metal detecting operations of the metal detector different from the first classification of metal detecting operations; and
installing the second configuration into the metal detector by replacing the first configuration, wherein the installing of the second configuration reconfigures the metal detector to operate according to the second configuration without replacing hardware components of the metal detector.

18. The computer-based tool of claim 17, wherein customizing the first configuration for the metal detector includes selecting a product profile that includes the first set of features, wherein the product profile is configured to support the first classification of metal detecting operations of the metal detector, and wherein customizing the second configuration for the metal detector further includes selecting a product profile that includes the second set of features, wherein the product profile is configured to support the second classification of metal detecting operations of the metal detector.

19. The computer-based tool of claim 17, wherein the first classification of metal detecting operations is based on a performance level of the metal detector, and wherein the second classification of metal detecting operations represents a different performance level achieved by the second configuration for the metal detector, the different performance level providing one of higher detection capabilities or lower detection capabilities compared to the first classification.

20. The computer-based tool of claim 17, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.
